(19) United States
(12) Patent Application Publication
(10) Pub. No.: US 2005/0196283 A1
(43) Pub. Date: Sep. 8, 2005

(54) Vane for a headbox in a paper machine

(76) Inventor: Janne Lappi, Jyvaskyla (FI)

Correspondence Address: STIENNON & STIENNON, 612 W. MAIN ST., SUITE 201, P.O. BOX 1667, MADISON, WI, 53701-1667, US

(21) Appl. No.: 11/069,583

(22) Filed: Mar. 1, 2005

(30) Foreign Application Priority Data
Mar. 3, 2004 (FI) 20040338

(51) Int. Cl. F03B 1/04

(52) U.S. Cl. 416/204 R

(57) ABSTRACT

A paper machine headbox vane has a vane component (2) and a pivot member (3) connected together with anchoring elements (4), which pass through holes (5, 6a, 6b) provided in both components (2, 3). The vane (1) is fastened to a headbox engagement groove in the headbox by the pivot member (3) which has two or more pivot member elements (3a₁, 3a₂, 3a₃) which have positioning holes for positioning the vane component (2) and the pivot member elements (3a₁, 3a₂, 3a₃) in relation to each other. A least one longitudinal hole in each element allows its free linear movement in relation to the vane component (2). The vane component (2) has a longitudinal opening (7), which receives the pivot member (3) with an opening between two successive pivot member elements (3a₁, 3a₂, 3a₃). The vane component (2) and the pivot member elements (3a₁, 3a₂, 3a₃) can be of different materials.

### CROSS REFERENCES TO RELATED APPLICATIONS

This application claims priority on Finnish Application 20046338, Filed Mar. 3, 2004, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a vane for the headbox of a paper machine or the like comprising a vane component and a pivot member connected together with anchoring elements, which pass through the holes provided in both components. The vane is intended to be fastened to an engagement groove in the headbox by means of a pivot member.

The paper machine or the like is used to refer to a paper, board or tissue machine.

Vanes are used in the slice channel of a headbox for attenuating large-scale turbulence and for converting it to small-scale turbulence, which prevents formation of fiber bundles and improves the quality of the paper produced. Vanes are also used in multi-layer headboxes for separating the various layers of flow.

Vanes are manufactured from plastic, composite materials and metal. They can have a uniform cross profile or taper in a wedge-like manner towards the free edge of the vane. The actual vane component is often connected to the headbox by means of a separate fastening component, which is connected to the vane component by gluing, welding or using anchoring elements.

A vane construction according to the last mentioned type is known from publication WO-A-9850625. Here a longitudinal opening created at the edge of the fastening component receives the edge of the vane component such that the fastening component encircles the edge of the vane component. The vane component and the fastening component are connected together with rivets, which pass through the holes provided in both components. The holes can be longitudinal in form, in which case they allow thermal expansion of the metallic fastening component in relation to the plastic vane component. A problem with this construction is a high step between the fastening component and the vane, which easily leads to that the flow detaches from the surface generating turbulence. Longitudinal holes may become filled with stock, which causes soiling. When the stock accumulated in the holes detaches, it may lead to formation of holes in the web and breaks in the paper production. Filling of the holes also prevents thermal expansion of the components.

Publication U.S. Pat. No. 6,491,793 makes known a solution, in which longitudinal grooves are machined to the top and bottom surface of the vane component, which grooves are intended to receive the projections included in the fastening component. Here, too, the fastening component encircles the edge of the vane component. The fastening component is preferably of a plastic material and it is composed of at least two successive parts, arranged at a distance from each other, which allows thermal expansion of the vane. The fastening components and the vane component are not locked together, in which case the fastening components can slide uncontrollably along the grooves in the vane component. Similar problems are associated with this solution as with the above-described vane. A flow-disturbing high step is now created between the turbulence generator and the vane.

For manufacturing a vane and for optimizing its characteristics it is often necessary to use in the vane construction at least two different materials, the physical properties of which, such as the water absorption capacity and thermal expansion coefficient, are different. Vane components made of different materials and with a differing geometry expand or contract in a different way for example as the temperature changes. In headbox conditions, stress states are easily created between the different components of the vane. If free expansion of the vane components is hindered, waves or other undesired deformations may appear in the vane cross profile.

### SUMMARY OF THE INVENTION

The object of the invention is to provide a vane, which is maintained straight and plane during use.

Another object is to avoid vane-internal stresses and deformations due to different swelling and thermal expansion of the materials used in the vane.

In addition, the object is to make the connection of the different parts of the vane easier than heretofore irrespective of whether they are made of the same material or different materials.

To achieve these objects the vane according to the invention is characterized in that the pivot member is composed of two or more pivot member elements, each of which comprises at least one positioning hole, which positions the vane component and the pivot member element in relation to each other, and at least one longitudinal hole, which allows the free linear movement of the pivot member element and the vane component in relation to each other.

Preferably the vane component is provided with a longitudinal opening, within which the pivot member elements are arranged successively such that there remains an opening between two successive pivot member elements. At the edge of each pivot member element there may be a cylindrical component, which remains outside the longitudinal opening and which can be arranged to the engagement groove in the headbox for fastening the vane to the headbox.

The positioning hole or holes can be located at the center, at the end, or between the end and center point of the pivot member element. The diameter of the positioning hole corresponds essentially to that of the anchoring element, whereas the length of the longitudinal holes is essentially greater than the diameter of the anchoring element. Generally the length of the hole is approximately 1.5-5 times the diameter of the anchoring element. The anchoring elements can be rivets, screws or similar elements. Between two successive pivot member elements there remains an opening, the size of which is preferably 1-10 mm.

In the construction according to the invention, a pivot member composed of several elements is fastened to a vane component in a method which allows a free stressless movement between the components made of different material and at the same time positions the different components of the vane in relation to each other. Achieving the desired vane geometry often requires using two different materials. For the pivot member, less expensive material can be used than for the vane component. A pivot member composed of several elements is notably easier to manufacture than one long pivot member. The invention also enables avoiding a formation of a step on the joint surface between the pivot member and the vane, which would be disadvantageous for the stock flow.

The invention is described below by making reference to the figures of the enclosed drawings to the details of which the invention is not intended to be restricted.

### BRIEF DESCRIPTION OF THE DRAWINGS

FIG. 1 is a perspective view of a vane.

FIG. 2 is an exploded perspective view of vane components of the vane of FIG. 1.

FIG. 3 is an enlarged fragmentary perspective view of vane parts of the vane of FIG. 1.

FIG. 4 is a perspective view of a vane seen from the inlet edge direction.

FIG. 5 is a sectional view of a vane inlet edge arranged in an engagement groove of a headbox.

### DESCRIPTION OF THE PREFERRED EMBODIMENTS

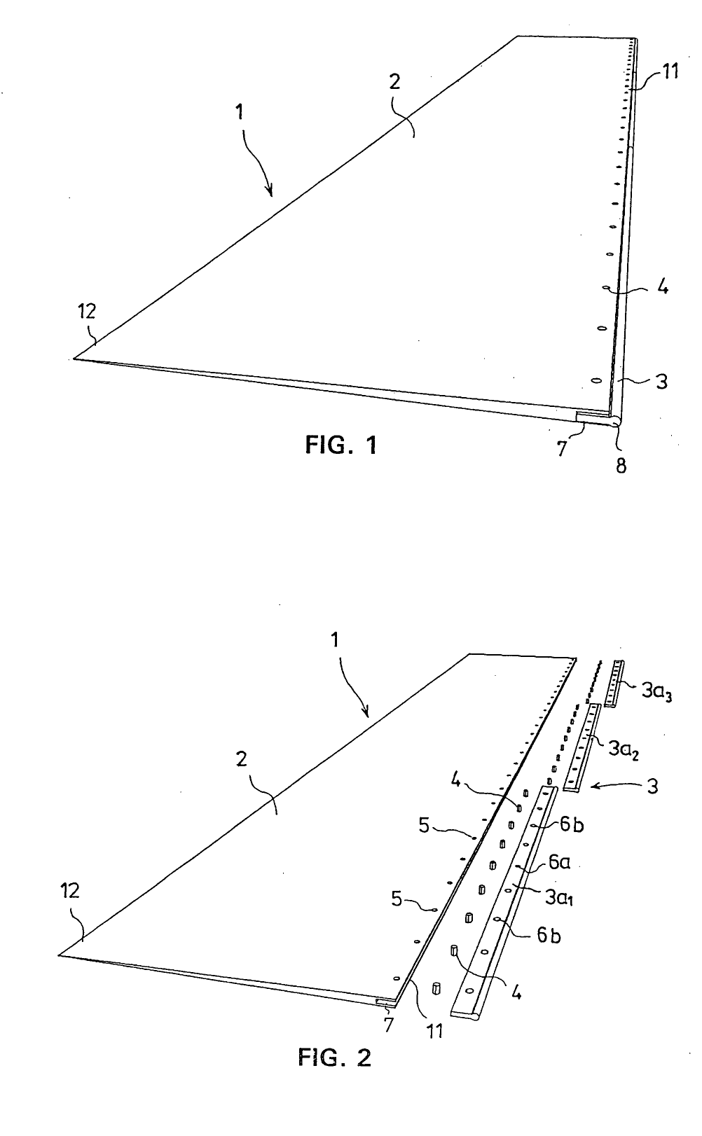

A headbox vane according to the invention is shown assembled in FIG. 1 and decomposed into parts in FIG. 2. The vane 1 comprises a vane component 2 and a pivot member 3 connected to its inlet edge, by means of which the vane can be fastened to an engagement groove in a headbox, as shown in FIG. 5. The cross section of the vane component 2 is wedge-like such that its thickness reduces from the inlet edge 11 towards the outlet edge 12. The inlet edge 11 is intended to be fastened to the headbox by means of the pivot member 3, and the outlet edge 12 is intended to float freely in the slice chamber flow of the headbox.

At the inlet edge 11 of the vane component 2 there is machined an opening 7 extending in the longitudinal direction of the vane 1, which is intended to receive the pivot member 3. The pivot member 3 is composed of three longitudinal pivot member elements 3a₁, 3a₂, 3a₃ arranged successively in the opening 7. These are fastened to the vane component 2 by means of anchoring elements 4, which are arranged to pass through holes 5 in the vane component 2 and through the holes 6a or 6b in the pivot member element 3a₁, 3a₂, 3a₃. The anchoring elements 4 can be rivets, screws, pins or similar devices. Connected to the edge of the pivot member element. 3a₁, 3a₂, 3a₃ there is a cylindrical component 8, which extends outside the opening 7.

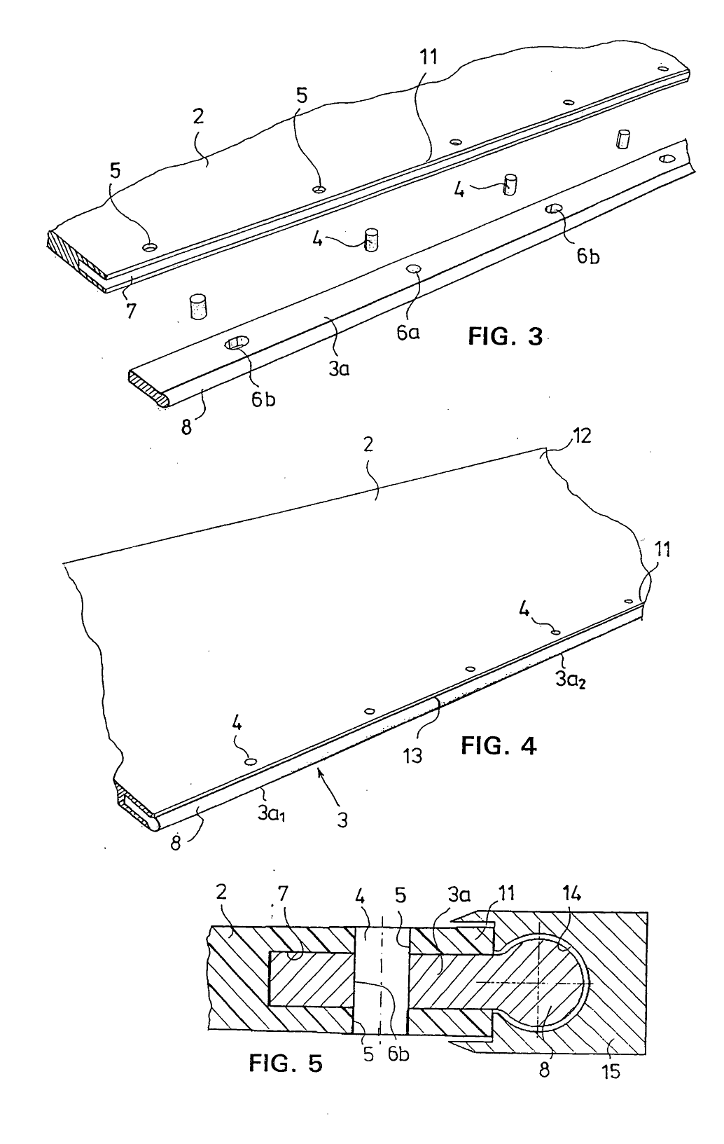

The joint between the vane component 2 and the pivot member component 3a is described below in more detail by making reference to FIGS. 3-5. Associated with the groove 7 there is a group of holes 5 located at regular intervals, which are dimensioned in such a manner that their diameter corresponds essentially to the diameter of the anchoring elements 4. The pivot member element is provided with holes 6a and 6b at corresponding intervals from each other. Each pivot member element 3a comprises a positioning hole 6a the diameter of which corresponds essentially to the diameter of the anchoring element 4 as well as several longitudinal holes 6b the length of which is preferably 1.5-5 times the diameter of the anchoring element 4. The positioning hole 6a can be located at the center of the pivot member element, at its end or in any position between the center point and the end. Between two successive pivot member elements 3a₁, 3a₂ there remains an opening the size of which is preferably 1-10 mm.

The anchoring element 4 passing through the positioning hole 6a keeps the pivot member element 3a in place in relation to the vane component 2. The anchoring elements 4 passing through the longitudinal holes 6b allow the vane component 2 and the pivot member element 3a to move linearly in relation to each other within the limits permitted by the length of the holes 6b. The gap or opening 13 left between two successive pivot member elements 3a₁, 3a₂ enables for the vane component 2 and the pivot member 3 assembled of several successive elements to adapt in relation to each other without generation of stresses in the vane component 2, which would force it to deform. The dimensions of the vane component 2 and the pivot member element 3a can then change for example as the result of different swelling of the materials or temperature variations.

FIG. 5 shows a vane according to the invention arranged in an engagement groove 14 in a headbox. The engagement groove is formed in a fastening component 15, which is arranged between two successive tube rows (not shown) of the turbulence generator of the headbox. As shown in FIG. 5, the pivot member elements 3a are completely protected within the engagement groove 14 and the vane component 2 groove 7 such that the stock suspension flow of the headbox cannot penetrate into the opening between two successive pivot member elements 3a. The longitudinal holes 6b are protected inside the groove 7 such that the stock suspension flow cannot block the holes 6b and thus hinder the linear movement between the pivot member element 3a and the vane component 2.

Preferably the ends of the anchoring elements 4 are embedded into the surface of the vane component 2 and covered with a protective layer of paint (not shown) such that the vane 1 surface is perfectly smooth.

The number of pivot member elements 3a can be greater than three as shown in the example. The number of the positioning holes 6a and the longitudinal holes 6b can vary depending on the length of the pivot member element 3a. The vane component 2 and the pivot member elements 3a can be any material commonly used in the vanes, such as composite, metal or plastic. The cross profile of the vane 2 does not need to be wedge-like, but it can be for example a flat plate.

The various details of the invention can deviate from the above described and vary within the scope of protection defined in the claims.

1. A vane for a headbox of a paper, board or tissue machine, the vane comprising:
a vane component having portions defining a plurality of holes;
a pivot member composed of a plurality of pivot member elements, each pivot member element having portions defining a plurality of holes;
a plurality of anchoring elements connecting the pivot member elements to the vane component by passing through the holes in the vane component and the holes in the pivot member elements, wherein each of said pivot member elements has at least one positioning hole which, when occupied by one of said anchoring elements which also occupies one of said vane holes, fixedly positions the vane component and the pivot member element in relation to each other; and
wherein each of said pivot member elements has at least one longitudinally extending positioning hole which is occupied by one of said anchoring elements which also occupies one of said vane holes which allows a free linear movement of the pivot member element and the vane component in relation to each other.

2. The vane of claim 1 wherein the vane component has a vane groove which receives therewithin the plurality of pivot member elements arranged in spaced relation, the spaced relation defining gaps between pivot member elements.

3. The vane of claim 2, wherein each pivot member element has an edge formed by a cylindrical component which remains outside the vane groove and which is engageable with a groove in a headbox for fastening the vane to the headbox.

4. The vane of claim 1 wherein each pivot member element at least one positioning hole is located at a center point of said pivot member element.

5. The vane of claim 1 wherein the vane component and the pivot member elements are made of a different material.

6. The vane of claim 1 wherein the anchoring elements are selected from the group consisting of: rivets, screws and pins.

7. The vane of claim 1 wherein the anchoring elements have two ends which do not extend above surfaces defined by the vane and wherein said ends are covered with a protective layer of paint.

8. A vane for a headbox of a paper, board or tissue machine comprising:
a vane component having an upper surface and a lower surface, and an outlet edge and an inlet edge, wherein the inlet edge defines a longitudinal direction;
portions of the vane which define a groove extending along the inlet edge;
portions of the vane which define a plurality of holes which extend across the groove from the upper surface to the lower surface, the groove dividing the holes into portions above the groove, and portions below the groove;
a plurality of pivot member elements, wherein each pivot member element has a portion which fits within the groove in the vane and a portion which fits within a fastening component in a headbox between rows of tubes in a tube bank, the pivot member elements being spaced apart along the vane inlet edge to form a gap about 1 mm to 10 mm;
portions of each pivot member element which define a first hole, and
portions of each pivot member which define at least one second hole which is elongated in the longitudinal direction;
an anchoring element positioned within each hole of the plurality of vane holes, each anchoring element extending between the hole portions above the groove and the hole portions below the groove;
wherein anchoring elements are fitted within the first holes of the plurality of pivot member elements, closely fitting the first holes, to fix the pivot member elements to the vane member; and
wherein anchoring elements are fitted within the second holes of the plurality of pivot member elements, to allow the portions of each pivot member forming the second holes to move in the longitudinal direction with respect to the vane component, said second holes attaching the pivot member elements to the vane member while allowing longitudinal movement thereof.

9. The vane of claim 8, wherein each pivot member element portion which fits within a fastening component in a headbox has an edge formed by a cylindrical component which remains outside the vane groove and which is engageable with a groove in the headbox for fastening the vane to the headbox.

10. The vane of claim 8 wherein at least one first hole is located at a center point of each pivot member element.

11. The vane of claim 8 wherein the material from which the pivot member elements are made is not the same as the material from which the vane component is made.

12. The vane of claim 8 wherein the anchoring elements are selected from the group consisting of rivets, screws, and pins.

13. The vane of claim 8 wherein the anchoring elements have two ends, and wherein the anchoring element ends do not extend beyond the upper surface and the lower surface of the vane and wherein said ends are covered with a protective layer of paint.

14. The vane of claim 9 wherein the pivot member elements are completely protected within the fastening component in the headbox and the vane component groove, such that a stock suspension flow of the headbox cannot penetrate into the gap between two successive pivot member elements, and the second holes are protected inside the vane component groove such that the stock suspension flow cannot block the second holes and thus hinder the longitudinal movement between the pivot member elements and the vane component.

15. A vane for a headbox of a paper, board or tissue machine, the vane comprising:
a vane component having portions defining a longitudinally extending groove;
portions of the vane component which define a plurality of holes which extend through said groove;
a plurality of pivot member elements which together comprise a pivot member, portions of the pivot member elements extending into the vane component groove, wherein the pivot member elements are spaced longitudinally from one another, such that a gap is defined between each pair of pivot member elements;
portions of each pivot member element which define a first hole;
portions of each pivot member element which define at least one second hole; and
a plurality of anchoring elements which each extend through one of the vane holes and either a first hole or a second hole in the pivot member elements to connect the pivot member elements to the vane component, wherein each second hole extends longitudinally a distance greater than a longitudinal dimension defined by a portion of the anchoring element which extends therethrough, the anchoring elements extending through the pivot member element first holes fixedly positioning the vane component and the pivot member element in relation to each other, and the anchoring elements extending through the pivot member element second holes allowing linear movement of the pivot member element and the vane component in relation to each other.

16. The vane of claim 15, wherein each pivot member element has portions defining a cylindrical component outside the vane groove and which is engageable with a groove in a headbox for fastening the vane to the headbox.

17. The vane of claim 15 wherein the vane component is formed of a material different than the material from which the pivot member elements are made.
